(19) United States
(12) Patent Application Publication
(10) Pub. No.: US 2026/0054377 A1
(43) Pub. Date: Feb. 26, 2026

(54) BENDING ACTUATOR APPARATUS AND FABRICATION METHOD

(71) Applicant: The Regents of the University of California, Oakland, CA (US)

(72) Inventors: Jonathan REALMUTO, Riverside, CA (US); Tuo LIU, Ontario, CA (US)

(21) Appl. No.: 19/310,482

(22) Filed: Aug. 26, 2025

Related U.S. Application Data
(60) Provisional application No. 63/686,957, filed on Aug. 26, 2024.

(51) Int. Cl. B25J 9/10; B25J 9/00; B25J 9/14

(52) U.S. Cl. CPC B25J 9/1045; B25J 9/0006; B25J 9/142

(57) ABSTRACT

An apparatus includes an actuator body having an elongated shape with two end-caps on opposite ends, the actuator body defining a cavity within the actuator body, a first material extending between the two end-caps forming a first portion of a wall of the cavity; and a second material extending between the two end-caps, forming a second portion of the wall of the cavity, wherein the two materials have different mechanical responses to longitudinal and radial loading.

### CROSS-REFERENCE TO RELATED APPLICATIONS

The present patent document claims the benefit of priority of U.S. Provisional Application 63/686,957, filed on Aug. 26, 2024, entitled “BENDING ACTUATOR APPARATUS AND FABRICATION METHOD.” The entirety of the aforementioned Provisional Application is incorporated by reference herein.

### TECHNICAL FIELD

The present document relates to biomedical instrumentation.

### BACKGROUND

People with movement disorders or disabilities often require assistance to perform daily activities. Wearable robots, also known as exoskeletons, are devices that can be worn by a person to augment their motion. These devices can be used to assist with walking, lifting, or other activities. Pneumatic actuators are particularly well-suited for wearable robots because they are lightweight, have high power-to-weight ratios, and are inherently compliant.

### BRIEF SUMMARY

Methods and apparatus for actuators that can be used in medical and industrial devices such as exoskeletons wearable robots are disclosed.

In one example aspect, an apparatus is disclosed. The apparatus includes an actuator body having an elongated shape with two end-caps on opposite ends, the actuator body defining a cavity within the actuator body, a first material extending between the two end-caps forming a first portion of a wall of the cavity, a second extending between the two end-caps, forming a second portion of the wall of the cavity, wherein the two materials have different mechanical responses to longitudinal (axial) and radial loading.

In another example aspect, a method of fabrication of the above apparatus is disclosed.

In another example aspect, a method of using the above apparatus to provide support to a robotic, industrial, or biological object.

In yet another example aspect, an exosuit system is disclosed. The exosuit system includes a hyper-bending actuator such as the above-described actuator, a mounting interface and a wearable body suit.

These, and other, aspects are described throughout the present document.

### BRIEF DESCRIPTION OF DRAWINGS

FIG. 1 depicts an example of a fabrication workflow.

FIG. 2A shows an example of a hyper-bending actuator illustrating working principles.

FIG. 2B depicts an example comparison of a hyper-bending actuator with a conventional pneumatic-based bending actuator.

FIG. 3A shows an example of a setup for testing force and torque characteristics.

FIG. 3B shows graphs of force and torque characteristics along the principal force (X) and torque (Y) axes for one embodiment of the hyper-bending actuator during isometric contractions as shown in FIG. 3A.

FIG. 4A shows an example prototype embodiment with hexagonal pattern and elliptical end-caps.

FIG. 4B shows an example of shortening (due to radial expansion) and elongation.

FIG. 4C shows details of an end-cap design.

FIG. 5A shows an example of a prototype embodiment as a wearable knee robot.

FIG. 5B shows details for the semi-rigid interface with hook/loop fastening of the prototype of FIG. 5A.

FIG. 6 shows a tabular listing of physical dimensions of a prototype example.

FIG. 7 is a flow chart for a fabrication method.

### DETAILED DESCRIPTION

### 1. Initial Discussion

People with movement disorders or disabilities often require assistance to perform daily activities. Wearable robots, also known as exoskeletons, are devices that can be worn by a person to augment their motion. These devices can be used to assist with walking, lifting, or other activities. Pneumatic actuators are particularly well-suited for wearable robots because they are lightweight, have high power-to-weight ratios, and are inherently compliant. However, traditional pneumatic actuators are limited in their bending capabilities.

### 2. Introduction

The present document discloses a new class of pneumatic-based soft actuators, called hyper-bending actuators, which can achieve large bending angles and high bending stiffness. While textile or fabric based pneumatic-based actuators have been demonstrated for a variety of motions and applications, including for the shoulder, elbow, fingers, hip, knee, the forearm, and modular devices which can be applied to a variety of joints, a major challenge is achieving large bending angles and high bending stiffness. Achieving large bending angles and high stiffness is important for creating wearable robots that can assist with a wide range of activities. Related conventional techniques include actuators with asymmetrical surfaces, strain-limiting layers of non-extensible material, elastomeric layers, full body suits, and helical actuators. Embodiments of the disclosed technology, collectively called the hyper-bending actuator, represent an improvement over conventional techniques by enabling greater curvature at lower pressure and higher bending stiffness.

Much of the existing technology in the area of pneumatic-based soft robotics uses textiles with various mechanical properties to construct actuators that achieve different motion modalities. These actuators are of great interest for body-mounted (wearable) robots. However, achieving high strength (e.g., force or torque output) is a primary challenge. The major limitation of the current state of the art is that current bending actuators constructed from soft materials do not achieve high force output.

Soft wearable robots, or exosuits, are a promising solution for delivering constant physical support to the mobility impaired because they can be made lightweight, compliant, and safe. However, major challenges include developing soft actuators that can deliver adequate force while maintaining a small volumetric form factor and attaching these actuators to the body in a comfortable way with efficient force transmission.

We have designed a new hyper-bending fabric actuator by leveraging compliance in two independent directions across the surface of an inflatable. The actuator exploits contrasting wall kinematics: an anisotropic textile (e.g., knit elastic) that elongates longitudinally with limited radial expansion, and a braided polymer mesh (e.g., nylon, PET) that expands radially when longitudinally shortened due to its geometry (variable braid angle) rather than intrinsic material extensibility. Pressurization of an internal bladder drives these differential deformations, producing controlled bending and increased bending stiffness.

Our design consists of a novel multi-material textile sleeve that incorporates braided mesh (e.g., nylon or PET expandable sleeving) and knit-elastic materials to realize hyper-bending actuators. The actuators incorporate 3D-printed end-caps that are attached to a semi-rigid human-robot interface to secure them to the body of a subject.

### 3. Example Features of Embodiments

In some embodiments, the device is a pneumatic-based soft actuator. It is composed of two different types of materials with different mechanical responses (e.g., textiles) with an inner bladder that inflates which causes the textiles to deform. The deformation is different for each textile layer and results in a hyper-bending shape when inflated. The force produced by the actuator is greater than the state of the art.

One advantageous feature is that some embodiments combine an anisotropic textile that elongates longitudinally with limited radial expansion (e.g., knit elastic) together with a braided mesh that radially expands when longitudinally shortened. A sleeve is formed cylindrically with each material spanning a longitudinal hemisphere; a pressurized bladder inside causes the knit side to lengthen longitudinally while the braid mesh side expands radially and shortens longitudinal, yielding a hyper-bent shape and a restoring moment about the neutral axis. When attached to the body with control hardware (solenoids) a user can control the internal pressure and therefore the force applied to joints.

Some embodiments of hyper-bending actuators are a new class of pneumatic-based soft actuators that can achieve large bending angles and high bending stiffness. These actuators are constructed using two distinct textiles that have different mechanical properties. A first textile exhibits anisotropic stiffness (high longitudinal compliance; low radial compliance), for example a knit-elastic textile, commonly used as waistbands in garments. A second textile is a braided mesh of substantially inextensible fibers or monofilaments (e.g., nylon, PET) that expands radially under longitudinal shortening. To create the actuator, the two textiles are mechanically joined, for example through sewing, to form a cylindrical sleeve. In some embodiments, a bladder is inserted into the cylindrical sleeve and affixed to the sleeve through mechanical fastening, for example a hose crimp. When the bladder is pressurized, the expanding volume exerts forces on the cylindrical sleeve. The anisotropic material (spanning longitudinally along one hemisphere) will lengthen longitudinally (but not radially), while the braided mesh (spanning longitudinally along the other hemisphere) expands radially and correspondingly shortens longitudinally. Through these combined motions, the actuator can develop controlled curvature and increased bending stiffness. By attaching the actuator across joints, such as the elbow, wrist, knee, or hip, and with proper control hardware, such as solenoid valves and pressure source(s), the actuator can be used to create wearable robots that augment human motion.

### 4. Example Fabrication Methods

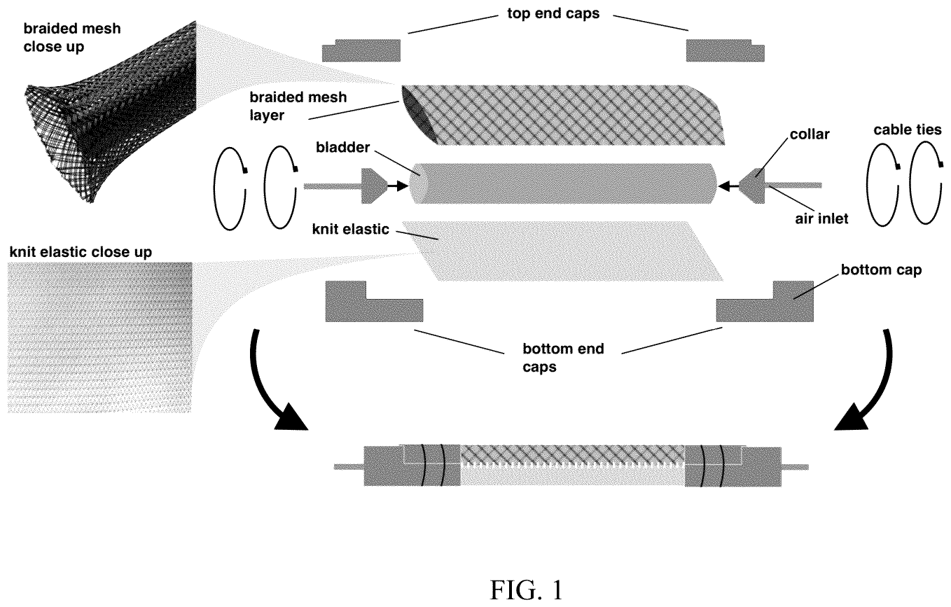

The hyper-bending actuator solves one or more problems of the prior art by integrating two distinct textiles that have different mechanical properties to achieve large bending angles and high bending stiffness. Materials cited herein are non-limiting examples. The first textile must exhibit anisotropic stiffness properties, with the longitudinal direction having large elasticity and the transverse (e.g., radial) direction being nearly inextensible, for example a knit-clastic textile, commonly used as waistbands in garments. The other textile is a braided mesh composed of inextensible fibers or monofilaments, such as nylon or polyester. The braided mesh tends to expand when shortened longitudinally because of the inextensible fiber. To create the actuator, the two textiles are mechanically joined, for example through sewing, to form a cylindrical sleeve. A bladder is inserted into the cylindrical sleeve and affixed to the sleeve through mechanical fastening, for example using 3D-printed collars (inserted into the bladder) and end-caps, or in another embodiment hose crimps. When the bladder is pressurized the expanding volume exerts forces on the cylindrical sleeve. The anisotropic material (spanning longitudinally along one hemisphere) will lengthen longitudinally (but not radially), while the braided mesh (spanning longitudinally along the other hemisphere) will shorten longitudinally and expand radially. Through these combined motions the actuator becomes bent and stiff. The fabrication method is summarized in FIG. 1.

As depicted in FIG. 1, a fabrication may be as follows. A top layer of braided mesh, which may be multiple layers thick (e.g., two layers), is sewn (or attached using another technique) to a bottom layer of knit-elastic textile to form a sleeve-like structure. A bladder is inserted into the sleeve and affixed to the sleeve through end-caps. The end-caps can be 3D printed or commercial hose-crimps.

### 5. Example Embodiments

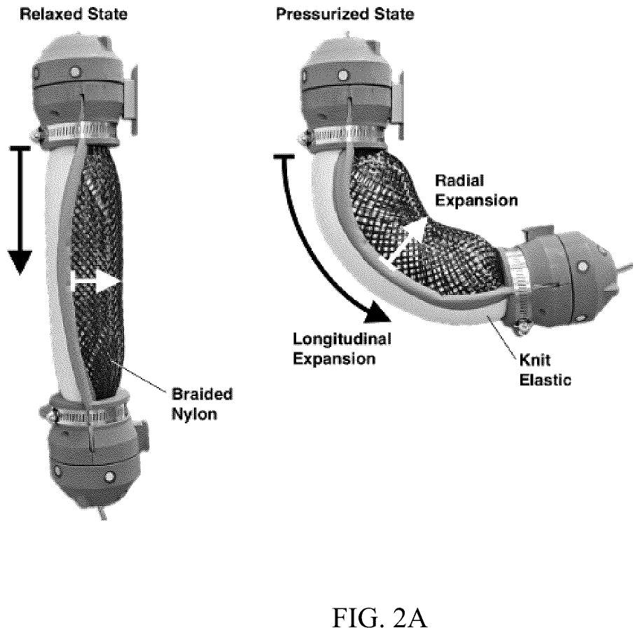

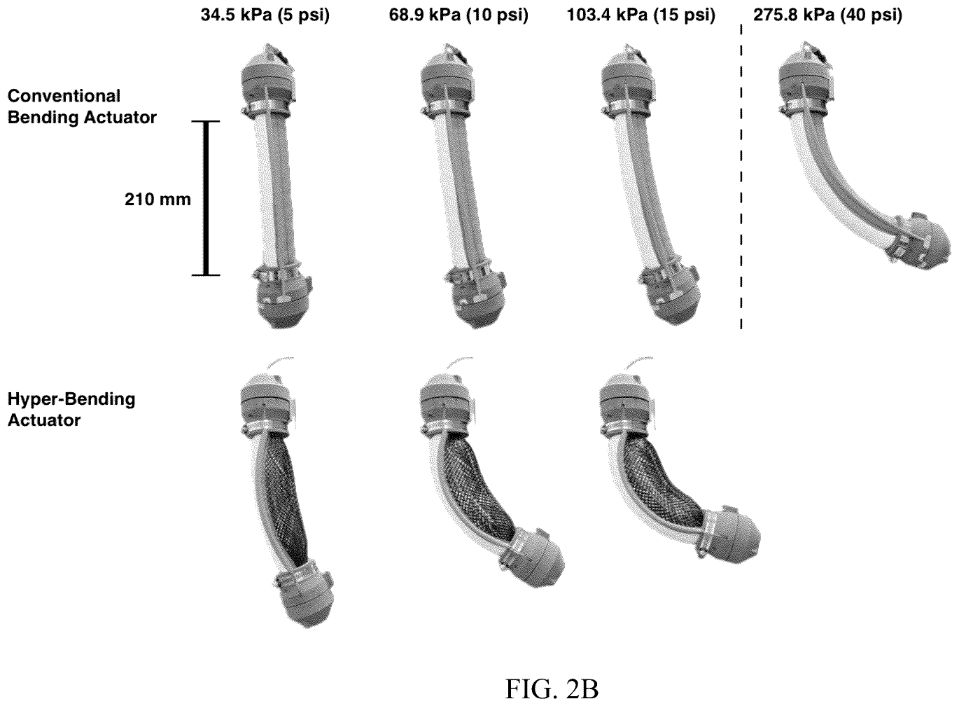

FIG. 2A depicts an example prototype of a hyper-bending actuator. The actuator is constructed with a braided polymer mesh layer, a knit elastic layer, and an internal bladder for pressurization. In the pressurized state, the braided mesh expands radially and the knit elastic elongates longitudinally. In some embodiments, the inserted bladder is received with minimal radial clearance within the two textile layers that form the cavity, but may not itself be securely fastened to the inner walls of the textile layers. During use, expansion of the bladder may cause the bladder to push against the textile layers to cause the desired longitudinal or radial expansion of the walls through wall-to-wall contact. Alternatively, the bladder may be fused within the cavity to the inside wall of one or both textile layers.

In one example embodiment, the actuators have a fabrication length of 210 mm and a nominal (deflated) sleeve diameter of approximately 38.2 mm. The internal bladder is composed of silicone rubber tubing with Durometer 35A, inner diameter 34.9 mm (1⅜ inches), and outer diameter of 38.1 mm (1½ inches). Other bladder materials may include latex or other elastomers, provided the bladder (i) is airtight, (ii) is radially compliant such that, under the operating pressure range, it expands to contact the sleeve and drive the differential wall motions (braid radial expansion and knit longitudinal elongation), and (iii) has a burst pressure exceeding the maximum operating pressure by an appropriate safety factor. In some embodiments, the bladder is received with minimal radial clearance within the sleeve to improve mechanical coupling. The hyper-bending actuator can achieve larger bending angles and higher bending stiffness at lower pressures. To achieve approximately the same bending angle as the hyper-bending actuator at 103 kPa of inflation pressure, the conventional actuator (constructed by substituting the braided mesh with a strain-limiting woven textile, e.g., high-denier ballistic nylon or other substantially inextensible woven fabric) must be inflated to 276 kPa of pressure.

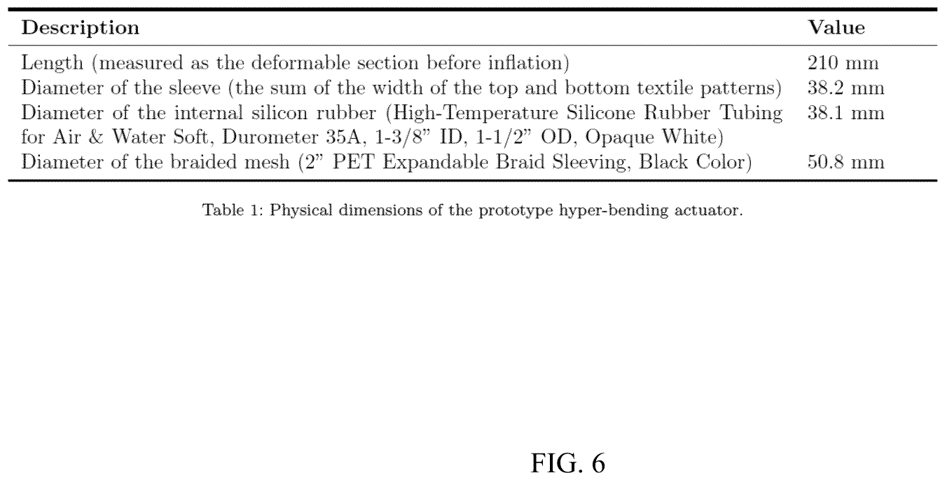

Table 1 is included in FIG. 6, and shows physical dimensions of an example embodiment.

Compared with a conventional pneumatic-based actuator (constructed by substituting an inextensible textile for the braided mesh) the hyper-bending actuator can achieve larger bending angles and higher bending stiffness at lower pressures. This can be seen in the inflation sequence shown in FIG. 2B.

As depicted in the top row, a conventional bending actuator requires higher pressure (and hence greater wall force) to achieve curvature comparable to the hyper-bending actuator; the latter achieves similar angles at approximately one-third the pressure.

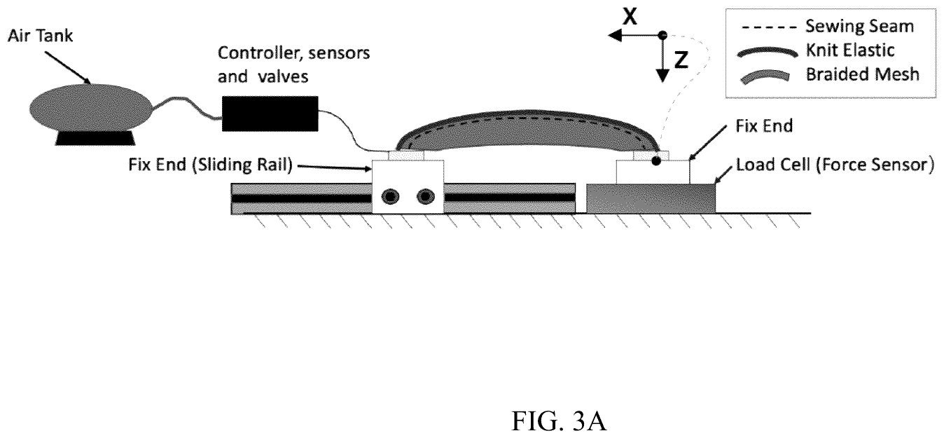

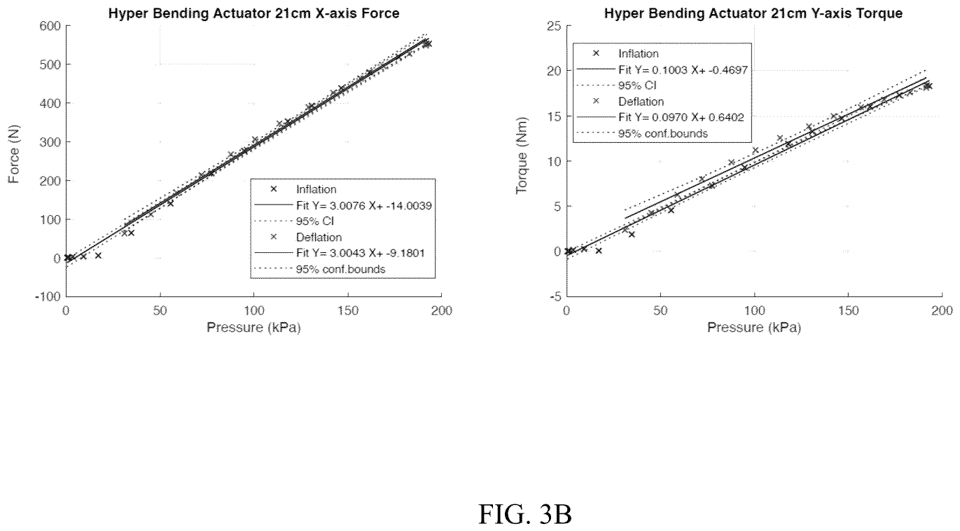

To demonstrate force characteristics of a hyper-bending actuator, an isometric loading test was performed. In this experiment both ends of the actuator are affixed with a load cell placed at one end. The results show that this actuator can produce nearly 600 N of force with an internal pressure of about 200 kPa. The setup and force characteristics for the isometric loading are shown in FIG. 3A.

As depicted in the setup, a compressed-air tank supplied pressurized air to the actuator through solenoid valves controlled with a digital controller, while pressure sensors monitored the internal actuator pressure. The hyper-bending actuator was placed on a platform with fixed ends and the induced forces and torques created through pressurization were measured with a 6-axis load cell.

FIG. 3B shows graphs of results performed on an example prototype. The left graph shows X-axis force results, which is the principal axis of induced force, while the right graph shows Y-axis torque results, which is the principal axis for induced torque. The graphs demonstrate one advantageous aspect of the proposed design that both the pressure versus force and the pressure versus torque graphs are approximately linear. The linearity provides the benefit that controlling of the actuator's force/torque may be performed with linear characteristics, and without a need to perform complex interpolations between different pressure values for a predicted force or torque value. The graphs also demonstrate another advantage of the proposed design, that the textiles are selected such that the hyper-bending actuator exhibits minimal hysteresis during a loading and unloading (inflation-deflation) sequence.

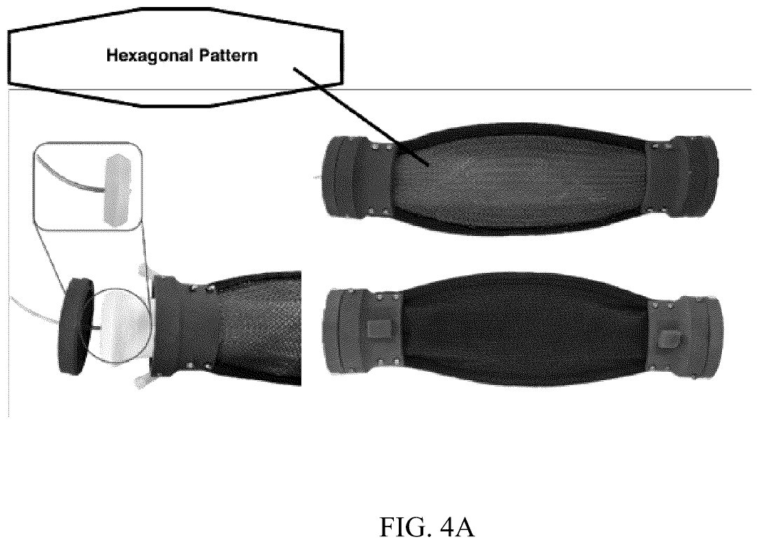

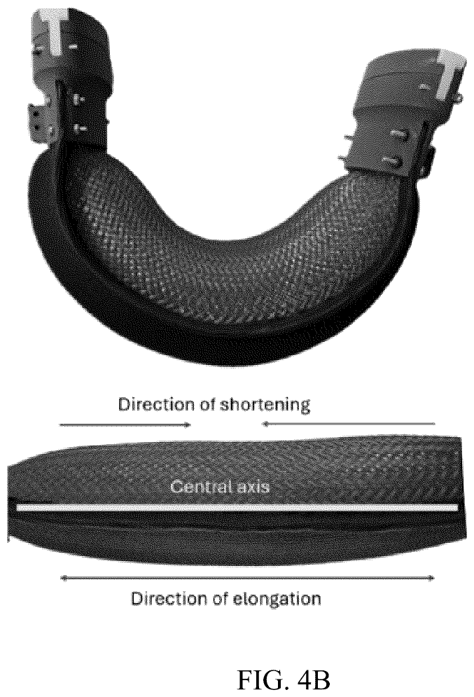

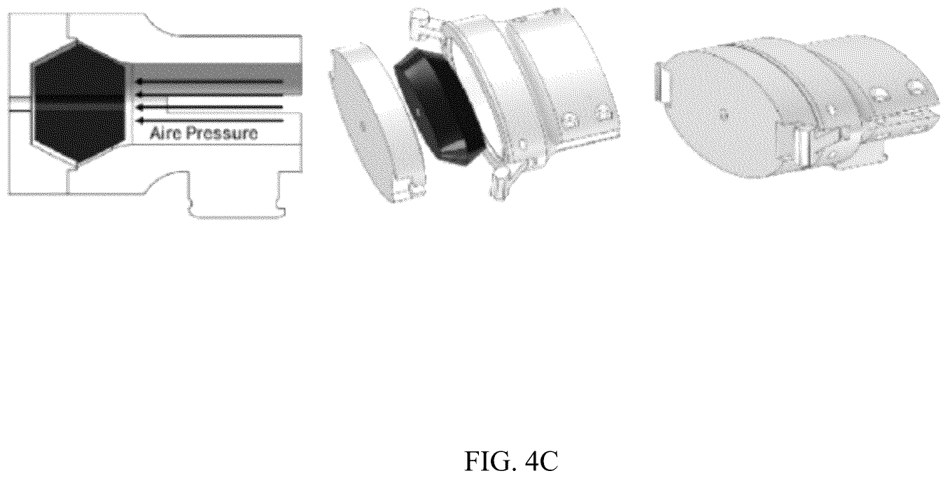

In one embodiment the hyper-bending actuator can be composed using rectangular patterns for each of the two textiles, as described previously. In another embodiment the actuator can use patterns that are cut into alternative shapes to enhance specific bending and stiffening properties. In one embodiment, for example, the two textiles can be cut into hexagonal sections to enhance the center bending. Another alternative embodiment is to adapt the end-caps to decrease the volumetric form-factor. This can be achieved using elliptical cylinders (instead of pure cylindrical shapes). The prototype shown in FIG. 4A consists of an embodied hyper-bending actuator with hexagonal patterns with elliptical end-caps.

FIG. 4B shows a hexagonal hyper-bending actuator in the inflated position (top) and deflated position (bottom), with the bottom figure showing an approximate central axis of elongation. To complete the exosuit, the hyper-bending actuators are engineered to be easily mounted to custom pants to orient them parallel to the knee so that the bending motion provides extension torques. By orienting them in the other direction the hyper-bending actuators can provide flexion torques.

FIG. 4C shows the end-cap used to secure the hyper-bending actuator. In the depicted embodiment, the end-cap has a honeycomb or hexagonal shape to allow the air pressure due to pressurization to be uniformly distributed in all directions, while at the same time providing a physical barrier (sidewalls) that stop the end-cap from being dislodged during use.

In one example embodiment, the braided polymer mesh material used to construct the hyper-bending actuator is the same material from the classic Mckibben artificial muscle, and the knit-clastic material, commonly used as waistbands in garments, has been extensively used by our research group for developing bending and twisting actuators. These two materials sewn together form the actuator sleeve, which is the functional part of the actuator and determines the resulting motion. In general, the sleeve can be constructed with different materials to program different motions. A silicone bladder with air inlets is placed in the sleeve and 3D-printed end-cap are used to mate the sleeve and bladder, as shown in FIGS. 4A and 4C.

### 6. Examples of Differential Deformation Properties of the First and Second Material

Bending arises from a mismatch in the forced deformation of the two wall portions when the bladder is pressurized. The knit side tends to elongate longitudinally with minimal change in radius, while the braided mesh side tends to expand radially and shorten longitudinally due to its geometry. Over the operating pressure range, curvature increases as (i) the difference between the knit's longitudinal elongation and the mesh side's longitudinal shortening grows, and as (ii) the difference between the mesh side's radial expansion and the knit's limited radial strain grows. In conventional bending embodiments, where a strain-limiting woven fabric replaces the braided mesh, the radial-expansion difference is small, so higher pressure is needed to achieve comparable curvature. The braided mesh embodiments amplify this radial-expansion difference and therefore produce larger curvature (and higher bending stiffness) at lower pressure.

### 7. Examples of Exosuit Applications

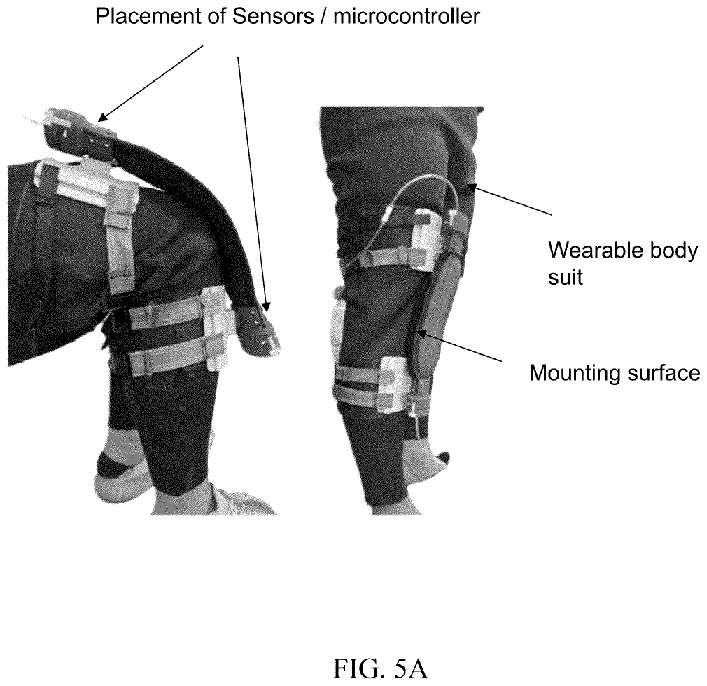

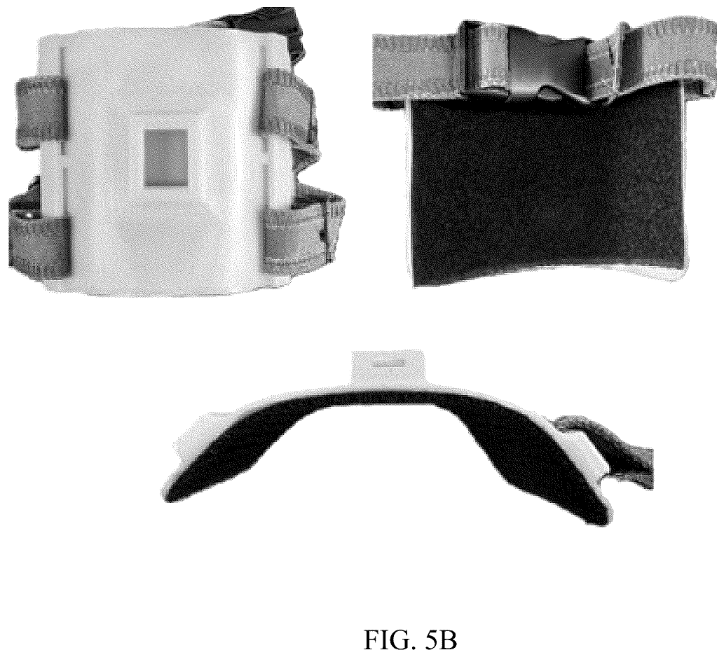

The exosuit system consists of three main components: the hyper-bending actuator, the human-robot mounting interface, and a body suit such as custom-made neoprene pants, as shown in FIGS. 5A-5B. The pants include a hook/loop interface that corresponds to the human-robot hook/loop. This allows for easy donning of the actuators and provide a level of modularity. Loop fabric is glued and sewn onto the pants for added strength. The mounting interface is attached to the loop fabric and secured with straps.

The hyper-bending actuators can be embodied as a wearable robot by affixing the actuators across different joints of the body. In one embodiment the actuator end-caps can include a semi-rigid interface with included strapping for attaching directly to the limbs. In another embodiment the semi-rigid interface can be constructed separately the end-caps, and the end-caps can include a joining feature that connects/disconnects to the semi-rigid interface. Another embodiment can include a semi-rigid interface include hook/loop fastenings which can mate to hook/loops attached to garments allowing for easy and fast donning. The prototype knee extension wearable robot shown in FIG. 5A includes a semi-rigid interface with hook/loop fastenings with end-caps that ‘snap’ into the semi-rigid interfaces. The same approach can used in analogous embodiments for flexion or extension of the elbow, hip, wrist, or other joints.

FIG. 5B shows additional details of the knee extension of FIG. 5A.

To attach the actuators to the body, we designed a human-robot mounting interface, as shown in FIG. 5B. This 3D-printed interface includes a mounting feature for attaching the actuators and it conforms to the shape of the human limb. The backside is lined with adhesive hook/loop fabric, allowing it to securely attach to custom hook/loop fabric on the pants with additional straps further securing it to the limb. The design ensures a large contact area for distributing the force generated by the actuator to minimize discomfort.

Our preliminary testing has shown the exosuit can provide and transmit substantial forces to the body.

To facilitate automatic control of the wearable robot embodiment a set of solenoid valves, pressure sensors, force sensors, inertial measurement units, electromyographic sensors and other body worn sensors with a computer or microcontroller can be used (shown in FIG. 5A). The solenoid valves can be used to control the inflation (e.g., activation to start operation) and deflation (e.g., deactivation to stop the movement) of the actuators. The pressure sensors can be used to monitor the pressure in the actuators. The force sensors can be used to measure the forces produced by the actuators. The inertial measurement units can be used to measure the orientation of the body. The electromyographic sensors can be used to measure the electrical activity of the muscles. The computer or microcontroller can be used to process the sensor data and control the solenoid valves.

### 8. Examples of Technical Solutions

The present document discloses various embodiments of a hyper-bending actuator and method of fabricating the actuator. The present document also discloses use of a hyper-bending actuator in an exoskeleton.
1. An apparatus, comprising: an actuator body (e.g., FIGS. 2A-2B, 4A-4B) having an elongated shape with two end-caps on opposite ends, the actuator body defining a cavity within the actuator body; a first material extending between the two end-caps forming a first portion of a wall of the cavity; a second material extending between the two end-caps forming a second portion of the wall of the cavity; wherein the two materials have different mechanical responses to longitudinal and radial loading. In some embodiments, the first portion is a first cylindrical hemispherical shape and the second portion has a second cylindrical hemispherical shape.
2. The apparatus of example 1, including an inflatable bladder within the cavity.
3. The apparatus of example 1, wherein the first material and the second material comprise textiles.
4. The apparatus of example 3, wherein one of first material or the second material includes a longitudinally extensible clastic material. The material may be, e.g., an anisotropic material that elongates in the longitudinal direction with limited radial expansion. Here, the anisotropic material may be a material that has a stiffness coefficient in the longitudinal direction on the order of 6.25 N/m per mm width, or in general a range of 3 to 12 N/m per mm width of textile, with the other (radial) directions practically strain-limiting. In some cases, this material may be called high strain material.
5. The apparatus of example 4, wherein the longitudinally extensible material comprises a knit clastic.
6. The apparatus of example 3, wherein one of the first material or the second material includes a material that expands radially under longitudinal shortening.
7. The apparatus of example 6, wherein the first material or the second material is comprised of a braided mesh selected from nylon, polyester (PET), aramid, cotton, glass fiber, carbon fiber, or other substantially inextensible fibers or monofilaments. Here, substantially inextensible may mean a material exhibiting strain properties as described herein.
8. The apparatus of claim 1, wherein, the different strain characteristics of the first material and the second material are such that application of a force along a direction of the two end-caps causes the combination of the first material and the second material to undergo longitudinal elongation on one side and radial expansion with longitudinal shortening on the other side, thereby bending the actuator body.
9. The apparatus of example 1, wherein the first material and the second material comprise rectangular or hexagonal patterns and wherein the two end-caps have a cylindrical cross-section.
10. The apparatus of example 2, further including a control hardware that is configured to control internal pressure of the inflatable bladder to cause a force to be exerted along a longitudinal direction of the apparatus between the two end-caps. In some embodiments, within an operating pressure range, the first material exhibits a greater longitudinal strain than the second material, and the second material exhibits a greater radial strain than the first material. In one advantageous aspect, such a differential behavior of the first material and the second material allows for a predicable and controlled bending of the actuator.
11. A method of fabrication of an apparatus, comprising: providing an actuator body having an elongated shape having two end-caps on opposite ends, the actuator body defining a cavity internal to the actuator body, attaching a first material extending between the two end-caps forming a first portion of a wall of the cavity; attaching a second material extending between the two end-caps, forming a second portion of the wall of the cavity, wherein the two materials having different mechanical responses to longitudinal and radial loading.
12. The method of example 11, including providing an inflatable bladder within the cavity.
13. The method of example 11, wherein the first material and the second material comprise textiles.
14. The method of example 13, wherein one of first material or the second material includes a longitudinally extensible elastic material. The longitudinally extensible elastic material may exhibit properties as described above.
15. The method of example 14, wherein the longitudinally extensible elastic material comprises a knit elastic.
16. The method of example 13, wherein one of the first material or the second material includes a material that expands radially under longitudinal shortening.
17. The method of example 16, wherein the material comprises a braided nylon.
18. An exosuit system, comprising: a hyper-bending actuator; a mounting interface; and a wearable body suit; wherein the hyper-bending actuator comprises: an actuator body having an elongated shape having two end-caps on opposite ends, the actuator body defining a cavity internal to the actuator body, a first material extending between the two end-caps forming a first portion of a wall of the cavity; a second material extending between the two end-caps, forming a second portion of the wall of the cavity, wherein the two materials having different mechanical response characteristics.
19. The exosuit system of example 18, wherein the end-caps include an interface to which a strapping is attachable, such that the strapping is able to affix the hyper-bending actuator to a body part of a subject.
20. The exosuit system of example 18, further including a set of solenoid valves, one or more pressure sensors, one or more force sensors, one or more inertial measurement units, one or more electromyographic sensors controlled with a computer or microcontroller that is configured to control inflation and deflation of an actuator that controls a bending operation of the hyper-bending actuator.

A method of fabrication of the apparatus recited in any of the above solutions.

A method of use of the apparatus of any of above solutions to provide flexible support to an industrial, a robotic or a live object.

The method of example 12, wherein the robotic or the live object comprises a bending knee.

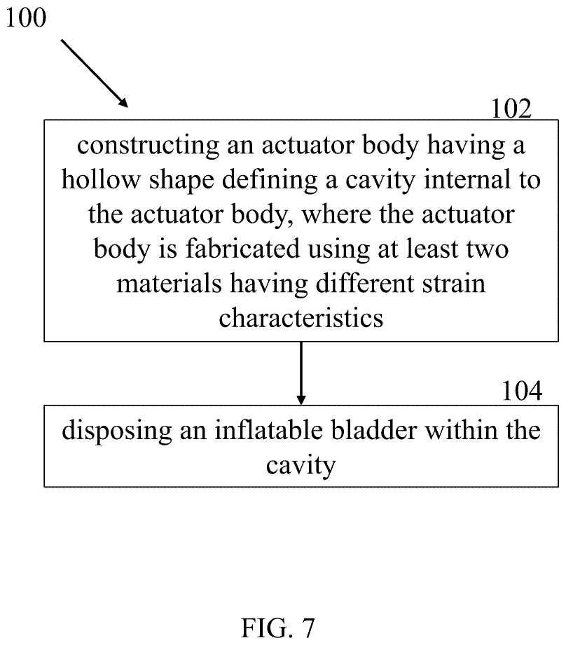

FIG. 7 depicts a method 100 of fabrication of a bending actuator disclosed herein. The method 100 includes constructing (102) an actuator body having a hollow shape defining a cavity internal to the actuator body, where the actuator body is fabricated using at least two materials having different mechanical properties such as strain characteristics and disposing (104) an inflatable bladder within the cavity. In some embodiments, a control hardware is coupled to the actuator body, where the control hardware is configured to control an internal pressure of the inflatable bladder. In some embodiments, the at least two materials include a longitudinally extensible elastic material such as knit elastic and a material that expands radially under longitudinal shortening such as braided polymer mesh (e.g., nylon or polyester (PET)). In some embodiments, the internal cavity is cylindrical in shape. Inflation or deflation of the bladder is used to cause a force to be exerted along a longitudinal axis (e.g., axial dimension representing the axis of the long dimension) to allow bending.

### 9. Conclusion

This work presents a design and fabrication framework for assistive exosuits for the lower limbs. Our main innovation is a hyper-bending actuator that can effectively transmit high forces in a low volumetric workspace. Compared to existing solutions, our design reduces the effort required to don a wearable robot onto the body.

Only a few implementations and examples are described, and other implementations, enhancements, and variations can be made based on what is described and illustrated in this patent document.

1. An apparatus, comprising;
an actuator body having an elongated shape with two end-caps on opposite ends, the actuator body defining a cavity within the actuator body,
a first material extending between the two end-caps forming a first portion of a wall of the cavity; and
a second material extending between the two end-caps, forming a second portion of the wall of the cavity,
wherein the two materials have different mechanical responses to longitudinal and radial loading.

2. The apparatus of claim 1, including an inflatable bladder within the cavity.

3. The apparatus of claim 1, wherein the first material and the second material comprise textiles.

4. The apparatus of claim 3, wherein one of first material or the second material includes a longitudinally extensible elastic material.

5. The apparatus of claim 4, wherein the longitudinally extensible elastic material comprises a knit elastic.

6. The apparatus of claim 3, wherein one of the first material or the second material expands radially under longitudinal shortening.

7. The apparatus of claim 6, wherein the first material or the second material is comprised of a braided mesh selected from nylon, polyester (PET), aramid, cotton, glass fiber, carbon fiber, or other substantially inextensible fibers or monofilaments.

8. The apparatus of claim 1, wherein, strain characteristics of the first material and the second material are different such that application of a force along a direction of the two end-caps causes combination of the first material and the second material to undergo longitudinal elongation on one side and radial expansion with longitudinal shortening on another side, thereby bending the actuator body.

9. The apparatus of claim 1, wherein the first material and the second material comprise rectangular or hexagonal patterns and wherein the two end-caps have a cylindrical cross-section.

10. The apparatus of claim 2, further including control hardware that is configured to control internal pressure of the inflatable bladder to cause a force to be exerted along a longitudinal direction of the apparatus between the two end-caps.

11. The apparatus of claim 1, wherein, within an operating pressure range, the first material exhibits a greater longitudinal strain than the second material, and the second material exhibits a greater radial strain than the first material.

12. A method of fabrication of an apparatus, comprising:
providing an actuator body having an elongated shape having two end-caps on opposite ends, the actuator body defining a cavity internal to the actuator body,
attaching a first material extending between the two end-caps forming a first portion of a wall of the cavity;
attaching a second material extending between the two end-caps, forming a second portion of the wall of the cavity,
wherein the two materials have different mechanical responses to longitudinal and radial loading.

13. The method of claim 12, including providing an inflatable bladder within the cavity.

14. The method of claim 12, wherein the first material and the second material comprise textiles, and wherein one of first material or the second material includes a longitudinally extensible elastic material.

15. The method of claim 14, wherein the longitudinally extensible elastic material comprises a knit elastic.

16. The method of claim 13, wherein one of the first material or the second material includes a material that expands radially under longitudinal shortening.

17. The method of claim 16, wherein the material comprises braided mesh of nylon, polyester (PET), or other substantially inextensible fibers or monofilaments.

18. An exosuit system, comprising:
a hyper-bending actuator;
a mounting interface; and
a wearable body suit;
wherein the hyper-bending actuator comprises:
an actuator body having an elongated shape having two end-caps on opposite side, the actuator body defining a cavity internal to the actuator body,
a first material extending between the two end-caps forming a first portion of a wall of the cavity;
a second material extending between the two end-caps, forming a second portion of the wall of the cavity,
wherein the two materials having different mechanical response characteristics.

19. The exosuit system of claim 18, wherein the end-caps include an interface to which a strapping is attachable, such that the strapping is able to affix the hyper-bending actuator to a body part of a subject.

20. The exosuit system of claim 18, further including
a set of solenoid valves, one or more pressure sensors, one or more force sensors, one or more inertial measurement units, one or more electromyographic sensors controlled with a computer or microcontroller that is configured to control inflation and deflation of an actuator that controls a bending operation of the hyper-bending actuator.
